(19) United States
(12) Patent Application Publication
(10) Pub. No.: US 2020/0336507 A1
(43) Pub. Date: Oct. 22, 2020

(54) GENERATIVE ATTACK INSTRUMENTATION FOR PENETRATION TESTING

(71) Applicant: SEW, INC., San Francisco, CA (US)

(72) Inventors: Daero LEE, San Francisco, CA (US); Yaniv KARTA, San Francisco, CA (US)

(21) Appl. No.: 16/599,113

(22) Filed: Oct. 10, 2019

Related U.S. Application Data
(60) Provisional application No. 62/835,415, filed on Apr. 17, 2019.

(51) Int. Cl. H04L 29/06; G06K 9/62; G06N 3/04; G06F 16/955

(52) U.S. Cl. CPC H04L 63/1433; G06F 16/955; G06N 3/0454; G06K 9/6269

(57) ABSTRACT

One embodiment of the present invention sets forth a technique for performing penetration testing. The technique includes generating, based on reconnaissance data collected from an environment, a set of potential attack vectors for the environment. The technique also includes classifying a subset of the potential attack vectors as viable attack vectors for the environment based on features associated with the set of potential attack vectors. The technique further includes applying a generative model to the viable attack vectors to produce a set of payloads for the viable attack vectors. Finally, the technique includes dispatching the set of payloads to the environment to assess security vulnerabilities in the environment.

### CROSS-REFERENCE TO RELATED APPLICATIONS

This application claims priority benefit of the U.S. Provisional Patent Application titled, “METHOD AND APPARATUS FOR MODEL AGNOSTIC AUTOMATED PENETRATION TESTING SYSTEM,” filed on Apr. 17, 2019 and having Ser. No. 62/835,415. The subject matter of this related application is hereby incorporated herein by reference.

### BACKGROUND

### Field of the Various Embodiments

Embodiments of the present invention generally relate to penetration testing, and more specifically, to generative attack instrumentation for penetration testing.

### Description of the Related Art

Penetration testing utilizes simulated attacks on environments to evaluate the security of the environments. For example, a penetration test may be performed on a website to detect vulnerabilities, determine strategies for mitigating the vulnerabilities, test security defenses, or achieve other goals related to enhancing the security of the website.

A penetration test is typically performed over multiple stages. First, reconnaissance of a target system is performed to gather information about potential attack vectors in the target system. Next, data collected in the reconnaissance stage is used to identify vulnerabilities in the target system, and payloads are generated and delivered to demonstrate the exploitability of the vulnerabilities.

Traditional penetration testing techniques typically involve manual identification of attack vectors and generation of payloads by penetration testing professionals. Because this process is time-consuming, penetration testing is difficult to scale to larger or more complex systems. Traditional techniques also use known patterns to generate payloads for certain types of attacks, which limits coverage of penetration tests with respect to less-well-known vulnerabilities or more innovative exploits.

As the foregoing illustrates, what is needed is a technological improvement for improving the comprehensiveness and scalability of penetration testing.

### SUMMARY

One embodiment of the present invention sets forth a technique for performing penetration testing. The technique includes generating, based on reconnaissance data collected from an environment, a set of potential attack vectors for the environment. The technique also includes classifying a subset of the potential attack vectors as viable attack vectors for the environment based on features associated with the set of potential attack vectors. The technique further includes applying a generative model to the viable attack vectors to produce a set of payloads for the viable attack vectors. Finally, the technique includes dispatching the set of payloads to the environment to assess security vulnerabilities in the environment.

One advantage of the disclosed embodiments includes the ability to identify viable attack vectors without requiring manual labeling of anomalies or vulnerabilities in the reconnaissance data. Another advantage includes the ability to dynamically and automatically adapt payloads to different targets, services, configurations, and/or topologies in the environment under test. Consequently, the disclosed techniques provide improvements in computer systems, applications, tools, and/or technologies that identify attack vectors and generate payloads for use in penetration testing.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computing device configured to implement one or more aspects of the present disclosure.

FIG. 2 is a more detailed illustration of the testing framework of FIG. 1, according to various embodiments.

FIG. 3 is a flow diagram of method steps for performing penetration testing, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

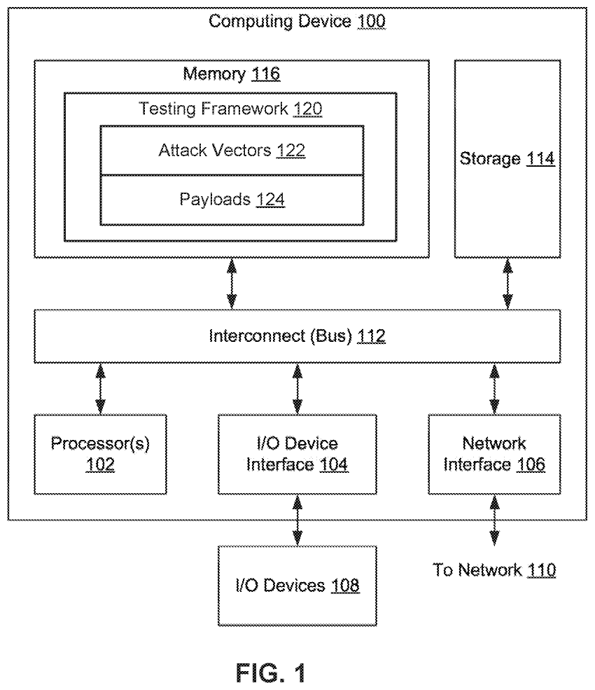

FIG. 1 illustrates a computing device 100 configured to implement one or more aspects of the present invention. Computing device 100 may be a desktop computer, a laptop computer, a smart phone, a personal digital assistant (PDA), tablet computer, or any other type of computing device configured to receive input, process data, and optionally display images, and is suitable for practicing one or more embodiments of the present invention. Computing device 100 is configured to run one or more components of a testing framework 120 for performing penetration testing, which resides in a memory 116. It is noted that the computing device described herein is illustrative and that any other technically feasible configurations fall within the scope of the present invention.

As shown, computing device 100 includes, without limitation, an interconnect (bus) 112 that connects one or more processing units 102, an input/output (I/O) device interface 104 coupled to one or more input/output (I/O) devices 108, memory 116, a storage 114, and a network interface 106. Processing unit(s) 102 may be any suitable processor implemented as a central processing unit (CPU), a graphics processing unit (GPU), an application-specific integrated circuit (ASIC), a field programmable gate array (FPGA), an artificial intelligence (Al) accelerator, any other type of processing unit, or a combination of different processing units, such as a CPU configured to operate in conjunction with a GPU. In general, processing unit(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 may include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 may be any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 may include non-volatile storage for applications and data, and may include fixed or removable disk drives, flash memory devices, and CD-ROM, DVD-ROM, Blu-Ray, HD-DVD, or other magnetic, optical, or solid state storage devices. Testing framework 120 may be stored in storage 114 and loaded into memory 116 when executed. Additionally, one or more sets of attack vectors 122 and/or payloads 124 generated by testing framework 120 may be stored in storage 114.

Memory 116 may include a random access memory (RAM) module, a flash memory unit, or any other type of memory unit or combination thereof. Processing unit(s) 102, I/O device interface 104, and network interface 106 are configured to read data from and write data to memory 116. Memory 116 includes various software programs that can be executed by processor(s) 102 and application data associated with said software programs, including testing framework 120.

Testing framework 120 includes functionality to perform penetration testing of a target environment. For example, testing framework 120 may be used to carry out a penetration test of a web-based environment (e.g., website, web application, web service, distributed system, etc.) to identify exploitable vulnerabilities in the environment.

During a penetration test, testing framework 120 identifies a number of attack vectors 122 that can be used to exploit vulnerabilities in the environment or gain unauthorized access to the environment. Continuing with the above example, attack vectors 122 for a web environment include, but are not limited to, application-programming interfaces (APIs), Uniform Resource Locators (URLs), parameters, services, endpoints, hosts, platforms, or other components of the web environment.

After attack vectors 122 are identified, testing framework 120 generates payloads 124 that are delivered via attack vectors 122 and allow the target system to be exploited. Continuing with the above example, payloads 124 that exploit vulnerabilities of the web environment include, but are not limited to, Structured Query Language (SQL) statements used in SQL injection attacks; client-side scripts used in cross-site scripting (XSS) attacks; user-supplied data in command injection attacks; URLs in Server-Side Request Forgery (SSRF) attacks; and/or session tokens, cookies, or parameters in authentication bypass attacks. Payloads 124 also, or instead, include file references in path or directory traversal attacks, state-changing requests in Cross-Site Request Forgery (CSRF) attacks, XPath queries in XPath injection attacks, Extensible Markup Language (XML) in XML External Entity (XXE) injection attacks, techniques for accessing sensitive files, and/or techniques for accessing misconfigured web services.

In one or more embodiments, testing framework 120 includes functionality to use machine learning models and techniques to automatically identify and instrument attack vectors 122 and payloads 124 during penetration testing for various types of exploits and vulnerabilities. As described in further detail below, these techniques adapt the penetration tests to different target environments without requiring manual identification of attack vectors 122 and creation of payloads 124 by penetration testing professionals. As a result, testing framework 120 improves the comprehensiveness, scalability, and flexibility of the penetration tests.

### Generative Attack Instrumentation for Penetration Testing

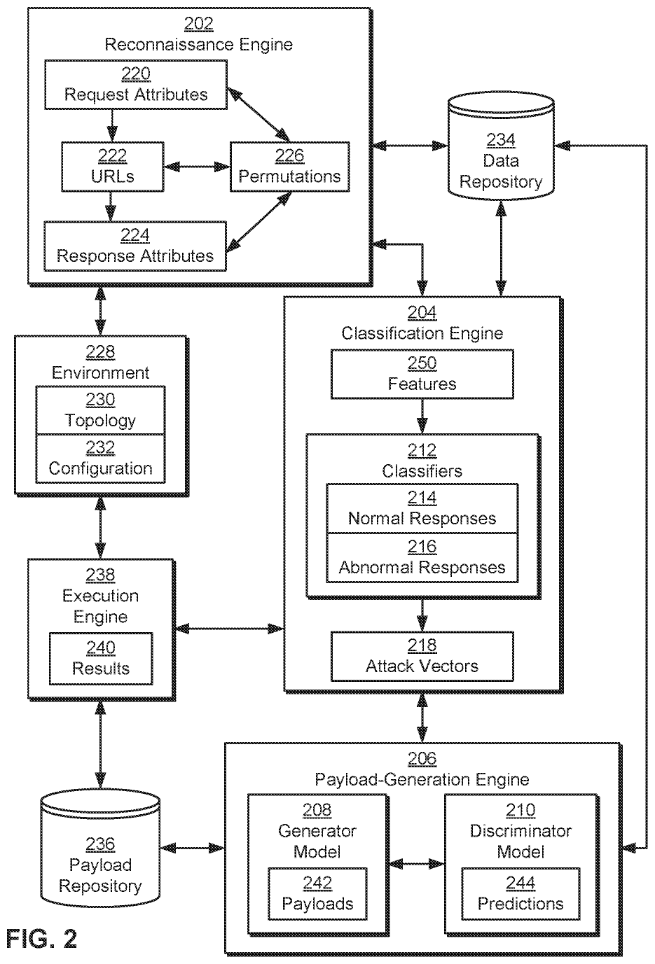

FIG. 2 is a more detailed illustration of testing framework 120 of FIG. 1, according to various embodiments of the present invention. As shown, testing framework 120 includes a reconnaissance engine 202, a classification engine 204, a payload-generation engine 206, and an execution engine 228. Each of these components is described in further detail below.

Reconnaissance engine 202 collects reconnaissance data related to an environment 228 that is the target of a penetration test. In some embodiments, environment 228 includes a web-based environment and/or another type of distributed system. In these embodiments, reconnaissance engine 202 includes a crawler and parser that collect and process the reconnaissance data based on the scope of the penetration test. For example, the crawler obtains the scope of the penetration test from a document storing a configuration and/or rules of engagement for the penetration test. The document may be stored in a data repository 234 and/or another type of data store. The scope includes, but is not limited to, one or more hosts, domain names, application-programming interfaces (APIs), services, applications, tools, URLs 222, networks, access points, and/or other components of environment 228. The scope can alternatively be unconstrained, which allows the crawler to explore all available components of environment 228.

In one or more embodiments, reconnaissance engine 202 generates requests with different sets of request attributes 220 to URLs 222 of environment 228. Reconnaissance engine 202 also receives responses to the requests and analyzes response attributes 224 of the responses to extract reconnaissance data from response attributes 224. Reconnaissance engine 202 further uses permutations 226 of request attributes 220, URLs 222, and/or response attributes 224 to generate additional requests. Reconnaissance engine 202 additionally uses the reconnaissance data to determine the topology 230 and/or configuration 232 of environment 228 in preparation for subsequent steps in penetration testing of environment 228. In turn, components of topology 230 and/or configuration 232 can be used to identify potential attack vectors 218 for environment 228.

More specifically, reconnaissance engine 202 includes functionality to obtain one or more URLs 222 in environment 228 from the rules of engagement and/or a configuration for the penetration test. Reconnaissance engine 202 generates requests with request attributes 220 that include the target URL(s) and/or parameters associated with the target URL(s) and transmits the requests to the target URL(s). Reconnaissance engine 202 also generates additional requests with request attributes 220 that contain permutations 226 of URLs 222 and/or parameter values from previous requests.

In some embodiments, reconnaissance engine 202 uses templates for payloads related to different types of exploits and/or environments to construct different types of requests to environment 228. Such include templates for environment payloads related to DNS registration services, CSRF attacks, and/or configuration 232 and/or settings in environment 228. Such templates also, or instead, include templates for web service payloads related to remote code execution, escalation of privileges, and/or command and code injection. Such templates also, or instead, include templates for database payloads related to SQL injection and/or other types of database-level attacks. Such templates also, or instead, include templates for protocol payloads that target specific protocols supported by environment 228. Such templates also, or instead, include templates for host payloads that are tailored to specific platforms, operating systems, and/or hardware used by hosts in environment 228.

In some embodiments, reconnaissance engine 202 obtains the templates from a data repository 234 and/or another data store. Reconnaissance engine 202 uses each template to construct a number of requests to environment, with each request containing a target URL and/or a different permutation and/or combination of parameter values to be transmitted to environment 228. Reconnaissance engine 202 also includes functionality to construct a chain of requests to explore advanced attacks or exploits related to combinations of vulnerabilities in environment 228.

Next, reconnaissance engine 202 transmits the requests to environment 228 and receives responses to the requests from environment 228. Reconnaissance engine 202 optionally parses response attributes 224 (e.g., Javascript, HyperText Markup Language (HTML), etc.) in headers or bodies of the responses to identify additional URLs 222, protocols, services, hosts, resources, and/or other components of topology 230 or configuration 232 of environment 228. Reconnaissance engine 202 builds topology 230 using the target and additional URLs 222; when a new URL is found in response attributes 224 of a given response, reconnaissance engine 202 transmits one or more requests to the additional URL to continue discovering and traversing elements of topology 230 in environment 228. Reconnaissance engine 202 also obtains, from response attributes 224, response times, error codes, response messages, and/or other characteristics of the responses.

Reconnaissance engine 202 optionally transmits the same request multiple times to environment 228. Reconnaissance engine 202 then aggregates response times, status codes, and other response attributes 224 of responses to the request into a distribution, average response time, and/or other metrics or statistics related to the request.

Reconnaissance engine 202 also includes functionality to identify parameters that are passed to environment 228 in response attributes 224 and/or other information collected from environment 228. Reconnaissance engine 202 additionally uses network scanning, ping sweeps, port scanning, packet sniffing, reverse Domain Name System (DNS) lookup, traceroute tools, and/or other techniques to discover hosts, ports, services, operating systems, routes, third-party components, databases, middleware, authentication mechanisms, user environments, web servers, and/or other components related to configuration 232. Reconnaissance engine 202 further includes functionality to collect additional reconnaissance data via search engines, articles, commercial data, social media, public records, social engineering, and/or other Open Source Intelligence (OSINT) tools and techniques.

Finally, reconnaissance engine 202 stores request attributes 220, URLs 222, response attributes 224, topology 230, configuration 232, and/or other reconnaissance data collected from environment 228 in data repository 234. Addresses, services, hosts, paths, parameter combinations, and/or other attributes associated with individual requests in the reconnaissance data represent potential attack vectors 218 for environment 228.

Classification engine 204 trains a set of classifiers 212 to identify normal responses 214 and abnormal responses 216 in data collected by reconnaissance engine 202. In some embodiments, classification engine 204 uses unsupervised learning techniques to train classifiers 212. After classifiers 212 are trained, classifiers 212 are able to distinguish between normal responses 214 and abnormal responses 216 from environment 228, which allows classification engine 204 to identify viable attack vectors 218 for environment 228 as those associated with abnormal responses 216.

First, classification engine 204 generates features 250 from data related to request-response pairs and/or chains of requests and responses collected by reconnaissance engine 202. In one or more embodiments, features 250 include representations of request attributes 220, response attributes 224, URLs 222, permutations 226, and/or other reconnaissance data collected by reconnaissance engine 202. For example, features 250 include term-frequencies-inverse document frequencies (tf-idfs), one-hot encodings, Huffman codings, fountain codes, embeddings, tokens, tags, attribute values, and/or other representations of fields in the reconnaissance data.

Classification engine 204 also, or instead, generates multiple groupings of features 250 that represent different types of attacks on environment 228. For example, classification engine 204 uses principal components analysis (PCA), k-means clustering, t-Distributed Stochastic Neighbor Embedding (t-SNE), and/or other techniques to group features 250 by types of attacks (e.g., XSS, CSRF, XML injection, SQL injection, XPath injection, authentication bypass, sensitive file access, etc.), “target” components associated with the attacks, potential attack vectors 218, and/or other attributes of request-response pairs associated with environment 228.

Classification engine 204 then applies one or more classifiers 212 to each grouping of features 250 to identify abnormal responses 216 as outliers or anomalies in the grouping. For example, classification engine 204 applies a support vector machine (SVM), isolation forest, local outlier factor (LOF), anomaly score, neural autoencoder, and/or other type of classifier or outlier detector to each grouping of features 250 to characterize individual features 250 in the grouping as outliers or non-outliers. In turn, classification engine 204 identifies normal responses 214 as those belonging to non-outliers in the grouping and abnormal responses 216 as those belonging to outliers in the grouping.

In other words, classifiers 212 use unsupervised learning techniques to identify abnormal responses 216 within a given grouping of normal responses 214 based on deviations in response times, error codes, status codes, response messages, and/or other response attributes 224 in the corresponding features 250. For example, an isolation forest in classifiers 212 detects abnormal responses 216 as those that can be isolated with fewer random splits in a forest of random trees than normal responses 214. In another example, a neural autoencoder detects abnormal responses 216 as those with output that deviates from the input features 250 by more than a threshold.

After classifiers 212 are trained, classification engine 204 optionally assesses the performance of each classifier using a small set of labeled data. For example, classification engine 204 uses a test dataset containing features 250 associated with request-response pairs that are labeled as successful or unsuccessful attacks to calculate a precision, recall, F-1 score, accuracy, receiver operator characteristic (ROC), and/or other measurement of machine learning model performance for each classifier. Classification engine 204 then selects one or more classifiers 212 for use in categorizing additional reconnaissance data collected from environment 228.

Classification engine 204 then identifies a set of viable attack vectors 218 for environment 228 based on classifications of normal responses 214 and abnormal responses 216 from classifiers 212. For example, classification engine 204 identifies viable attack vectors 218 as hosts, paths, services, URLs 222, ports, and/or other components of environment 228 that are associated with abnormal responses 216.

In turn, payload-generation engine 206 generates payloads 242 for attack vectors 218 that are identified as viable by classification engine 204. In some embodiments, payload-generation engine 206 uses a generative adversarial network (GAN) to produce payloads 242. As shown, the GAN includes a generator model 208 that generates payloads 242 for attack vectors 218 identified as viable by classification engine 204, as well as a discriminator model 210 that outputs predictions 244 of payloads 242 as real or fake.

Generator model 208 includes functionality to generate payloads 242 based on data related to attack vectors 218. Input into generator model 208 includes a target URL associated with an attack vector, parameter names and types associated with the URL, response times, error codes, and/or other types of request attributes 220 or response attributes 224 of requests and responses related to the attack vector.

In some embodiments, generator model 208 includes a long short-term memory (LSTM), recurrent neural network, and/or other type of neural network that produces one or more sequences of tokens representing one or more payloads 242 for the attack vector, based on the input. For example, generator model 208 produces an output sequence Y_{1:T}=(y₁, . . . , yₜ, . . . , y_{T}), where each yₜ is selected from a vocabulary of candidate tokens. At a given time step t, the state of generator model 208 includes the currently selected tokens (y₁, . . . , yₜ₋₁), and the action of generator model 208 includes the next token yₜ to select.

Discriminator model 210 categorizes payloads 242 generated by generator model 208 as real or fake. For example, discriminator model 210 includes a convolutional neural network, deep neural network, recurrent convolutional neural network, and/or another type of neural network that outputs a value between 0 and 1 representing the likelihood that a sequence inputted into discriminator model 210 is a real payload.

In one or more embodiments, payload-generation engine 206 and/or another component of the system perform “pre-training” of generator model 208 and discriminator model 210 before generator model 208 and discriminator model 210 are used to generate and select payloads 242 for use in penetration testing of environment 228. During such pre-training, the component uses maximum likelihood estimation (MLE) to train generator model 208 to generate synthetic payloads 242, given a distribution of payloads in a training dataset.

For example, the component obtains a training dataset containing payloads that represent proofs of concept of various exploits of web-based and/or distributed environments. The component then trains generator model 208 to minimize the cross-entropy between the distribution of payloads in the training dataset and the synthetic payloads outputted by generator model 208, based on input that includes characteristics of the type of attack and/or attack vector. As a result, generator model 208 learns to generate synthetic payloads 242 that can be used to compromise a target environment without creating denial-of-service-induced scenarios.

Next, the component uses labeled training data to train discriminator model 210 to distinguish between real payloads and synthetic payloads generated by generator model 208. For example, the component uses the pre-trained generator model 208 to generate synthetic payloads 242 and assigns labels of 0 to the synthetic payloads. The component also obtains real payloads used in attacks and/or penetration testing of various environments and assigns labels of 1 to the real payloads. The component then trains discriminator model 210 to output the labels after the corresponding payloads are inputted into discriminator model 210.

After pre-training is complete, the component alternately trains generator model 208 and discriminator model 210. In some embodiments, the component uses a policy gradient method to train generator model 208. The policy gradient method includes determining a “reward” for a sequence (i.e., a synthetic payload) outputted by generator model 208 as the estimated probability outputted by discriminator model 210 that the sequence is real. The policy gradient method also includes training generator model 208 to generate a sequence, starting with a given initial state, that causes discriminator model 210 to classify the sequence as real.

For example, generator model 208 includes an objective to generate a sequence from a start state s₀ to maximize its expected end reward:

$$J ( θ ) = 𝔼 [ {R}_{T} \vert {s}_{0} , θ ] = {\sum }_{{y}_{1} ∈ y} {G}_{θ} ( {y}_{1} \vert {s}_{0} ) \cdot {Q}_{{D}_{φ}}^{{G}_{θ}} ( {s}_{0} , {y}_{1} ) ,$$

where R_{T} is the reward for a complete sequence from discriminator model 210 D_{ϕ}, and Q_{D}_{_{ϕ}}^{G}^{_{θ}}(s, a) is an “action-value” function representing the expected accumulative reward starting from state s, taking action a, and following policy (i.e., generator model 208) G with parameters θ. The action-value function is estimated as the output of discriminator model 210:

Q_{D}_{_{ϕ}}^{G}^{_{θ}}(a=y_{T}, s=Y_{1:T-1})=D_{ϕ}(Y_{1:T})

To evaluate the action value for an intermediate state in generator model 208, an N-time Monte Carlo search is used to sample the unknown last T−t tokens:

{Y_{1:T}ⁿ, . . . , Y_{1:T}^{N}}=MC^{a}^{_{β}}(Y_{1:1}; N),

where Yⁿ_{1:T}=(y₁, yₜ) and Yⁿ_{t+1:T} is sampled based on a roll-out policy (i.e., generator model 208 or a simplified version of generator model 208) and the current state. As a result:

$${Q}_{{D}_{φ}}^{{G}_{θ}} ( s = {Y}_{1 : t - 1} , a = {y}_{t} ) = \{ \begin{matrix}\frac{1}{N} {\sum }_{n = 1}^{N} {D}_{φ} ( {Y}_{1 : T}^{n} ) , {Y}_{1 : T}^{n} ∈ {MC}^{{G}_{β}} ( {Y}_{1 : t} ; N ) & for t < T \\ {D}_{φ} ( {Y}_{1 : t} ) & for t = T ,\end{matrix}$$

where the function is iteratively defined as the next-state value starting from state s′=Y_{1:T} until the end of the sequence is reached.

The component similarly retrains discriminator model 210 periodically to improve the accuracy of predictions 244. For example, the component trains discriminator model 210 to distinguish between a latest set of synthetic payloads 242 produced by generator model 208 and real payloads. After a new version of discriminator model 210 is produced, the component retrains generator model 208 to maximize its expected end reward.

Execution engine 238 carries out attacks on environment 228 by dispatching payloads 242 that are generated by generator model 208 and categorized as real by discriminator model 210. For example, payload-generation engine 206 stores, in a payload repository 236, payloads 242 from generator model 208 associated with predictions 244 from discriminator model 210 that are higher than a threshold likelihood of being real. Execution engine 238 retrieves the payloads from payload repository 236 and dispatches the payloads according to a policy and/or schedule associated with the rules of engagement for a penetration test of environment 228.

Execution engine 238 also uses classifiers 212 and/or other functionality of classification engine 204 to generate results 240 of the penetration test. In one or more embodiments, execution engine 238 collects response attributes 224 from environment 228 for each payload dispatched to environment 228. Next, execution engine 238 applies one or more classifiers 212 from classification engine 204 to the collected response attributes 224 and/or other attributes associated with the payload. When classifiers 212 determine that response attributes 224 represent an abnormal response from environment 228, execution engine 238 specifies, in results 240, that the attack represented by the payload was successful. When classifiers 212 determine that response attributes 224 represent a normal response from environment 228, execution engine 238 specifies, in results 240, that the attack represented by the payload was unsuccessful.

Payload-generation engine 206 additionally uses results 240 to perform subsequent training and/or reinforcement of generator model 208 and/or discriminator model 210. In some embodiments, payload-generation engine 206 uses results 240 to regulate rewards (i.e. predictions 244) outputted by discriminator model 210 in response to payloads 242 produced by generator model 208. As mentioned above, a payload generated by generator model 208 that is determined to be real by discriminator model 210 is dispatched by execution engine 238 during penetration testing of environment 228. When the dispatched payload is subsequently classified as successful by one or more classifiers 212, the reward associated with the payload is used to update parameters of generator model 208 and/or discriminator model 210. When the dispatched payload is classified as unsuccessful by classifiers 212, the reward is multiplied by a configured constant (e.g., 0.95) to decrease the magnitude of the reward before generator model 208 and/or discriminator model 210 are updated based on the reward. Thus, results 240 can be fed back into generator model 208 and/or discriminator model 210 to improve the accuracy and/or effectiveness of payloads 242 selected for use in penetration testing.

The operation of reconnaissance engine 202, classification engine 204, payload-generation engine 206, and execution engine 238 is illustrated using the following example. First, reconnaissance engine 202 collects reconnaissance data from a number of URLs 222 under the scope of a penetration test of a website. An example set of reconnaissance data associated with a request-response pair includes the following representation:

{“startedDateTime”: “2019-03-29T11:17:59.770444+00:00”, “request”: {“method”:
“POST”, “url”: “http://xyz.com:8080/webapp/login.do”, “httpVersion”: “HTTP/1.1”,
“cookies”: [ ], “headers”: [{“name”: “Host”, “value”: “xyz.com:8080”}, {“name”: “user-
agent”, “value”: “pentoma_v0.3whfvjcglaa”}, {“name”: “Accept-Encoding”, “value”:
“gzip, deflate}, {“name”: “Accept”, “value”: “*/*”}, {“name”: “Connection”, “value”:
“keep-alive}, {“name”: “Accept-Language”, “value”: “en-US”}, {“name”: “Content-
Length”, “value”: “401, {“name”: “Content-Type”, “value”: “application/json”},
{“name”: “Referer”, “value”: “http://xyz.com:8080/webapp/”}], “queryString”: [ ],
“headersSize”: 367, “bodySize”: 40, “postData”: {“mimeType”: “application/json”,
“text”: “{\“username\”: \“cHRt\”, \“password\”: \“cHRt\”}”, “params”: [ ]}}, “response”:
{“status”: 200, “statusText”: “OK”, “httpVersion”: “HTTP/1.1”, “cookies”: [ ], “headers”:
[{“name”: “Expires”, “value”: “Thu, 01 Jan 1970 00:00:00 GMT”}, {“name”: “Cache-
Control”, “value”: “no-cache, no-store, must-revalidate}, {“name”: “Access-Control-
Allow-Headers”, “value”: “Origin, X-Requested-With, Content-Type, Accept, Access-
Control-Allow-Headers, Authorization”}, {“name”: “X-XSS-Protection”, “value”:
“1;mode=block”}, {“name”: “Pragma”, “value”: “no-cache}, {“name”: “X-Frame-
Options”, “value”: “SAMEORIGIN”}, {“name”: “Content-Disposition”, “value”:
“inline;filename=f.txt”}, {“name”: “Date”, “value”: “Fri, 29 Mar 2019 11:17:59 GMT”},
{“name”: “Connection”, “value”: “keep-alive}, {“name”: “Access-Control-Allow-
Origin”, “value”: “http://xyz.com:8080”}, {“name”: “Access-Control-Allow-Credentials”,
“value”: “true}, {“name”: “X-Content-Type-Options”, “value”: “nosniff”}, {“name”:
“Transfer-Encoding”, “value”: “chunked”}, {“name”: “Content-Type”, “value”:
“application/json;charset=UTF-8”}, {“name”: “Access-Control-Allow-Methods”,
“value”: “GET, POST”}, {“name”: “Access-Control-Max-Age”, “value”: “3600”}],
“content”: {“size”: 217, “compression”: 0, “mimeType”:
“application/json;charset=UTF-8”, “text”:
“{\“userId\”:null,\“userToken\”:null,\“username\”:null,\“firstName\”:null,\“lastName\”:nu
ll,\“userProfile\”:null,\“errorMessage\”:\“User is not active or does not
exists.\”,\“autoLogoutTime\”:null,\“activityCodeList\”:null,\“isAdmin\”:null}”},
“redirectURL”: ”, “headersSize”: 825, “bodySize”: 217}, “cache”: { }, “timings”:
{“send”: 3, “receive”: 6, “wait”: 1066}, “serverIPAddress”: “53.159.190.010”}

More specifically, the reconnaissance data above includes the date and time of the request, attributes related to the request (e.g., request method, URL, HTTP version, etc.), parameters and values in the header and body of the request, attributes of the response (e.g., status code, status message, etc.), and/or resource timing attributes (e.g., send, receive, and wait times) associated with the request-response pair.

Next, classification engine 204 converts the collected reconnaissance data into a corresponding set of features 250. For example, classification engine 204 generates one-hot encodings, Huffman encodings, principal components, tokens, tags, embeddings, clusters, and/or other representations of attributes in the reconnaissance data.

Classification engine 204 then creates classifiers 212 that identify normal responses 214 and abnormal responses 216 in the reconnaissance data. After analyzing features 250, classifiers 212 identify abnormal responses 216 and, in turn, viable attack vectors 218 associated with SQL injection attacks of one or more target URLs 222 in environment 228.

Payload-generation engine 206 uses generator model 208 and discriminator model 210 to produce payloads 242 for attack vectors 218 identified as viable by classification engine 204. For example, payload-generation engine 206 produces two types of payloads 242 for a SQL injection attack of environment 228. The first type of payload includes two different values of an “id” parameter:

id=\\″))+and+(SELECT+*+FROM+[ODBC;DRIVER=SQL+SERVER;Server=1.1.1.1;D
ATABASE=w].a.p)\\u000 0
id=\\″));waitfor/**/delay/**Λ‘0:0:7\’-1 id=bb3e43f2-7187-4df6-a26f-
8dc5854d6d78;SELECT PG_SLEEP(5)--

The second payload includes two different values of a “maxResults” parameter:

maxResults=20%3BSELECT%20PG_SLEEP%285%29-
maxResults=20%29%20AND%208566%3DDBMS_PIPE.RECEIVE_MESSAGE%28
CHR%28119%29%7C%7C
CHR%28101%29%7C%7CCHR%2881%29%7C%7CCHR%2889%29%2C5%29%2
0AND%20%289849%3D98 49

Finally, execution engine 238 dispatches the generated payloads 242 to environment 228 during a scheduled penetration test of environment 228 and determines results 240 of the penetration test based on responses to the dispatched payloads 242 from environment 228. For example, execution engine 238 dispatches payloads 242 to environment 228 and/or a virtualized version of environment 228. Execution engine 238 collects response attributes 224 of responses to payloads 242 from environment 228 and applies classifiers 212 to response attributes 224 to classify the corresponding attacks as successful or unsuccessful. Execution engine 238 and/or another component include the classifications in a report and/or another representation of results 240 of the penetration test. Execution engine 238 and/or the component also provide results 240 to payload-generation engine 206, and payload-generation engine 206 uses results 240 to update generator model 208 and/or discriminator model 210.

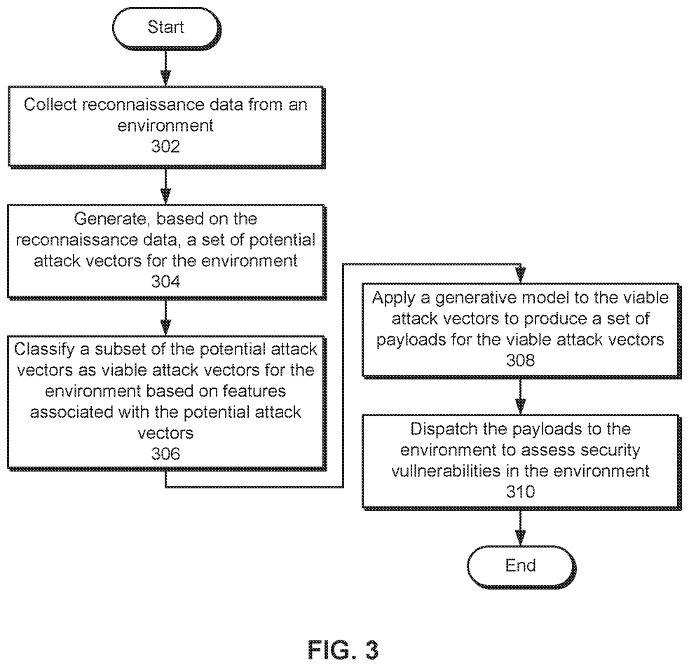

FIG. 3 is a flow diagram of method steps for performing penetration testing, according to various embodiments. Although the method steps are described in conjunction with the systems of FIGS. 1 and 2, persons skilled in the art will understand that any system configured to perform the method steps in any order falls within the scope of the present disclosure.

As shown, reconnaissance engine 202 collects 302 reconnaissance data from an environment. For example, reconnaissance engine 202 uses a crawler to identify and/or discover target URLs in a web environment and construct a topology of the web environment. Reconnaissance engine 202 also uses network scanning, ping sweeps, port scanning, packet sniffing, reverse DNS lookup, traceroute tools, and/or other techniques to discover hosts, ports, services, operating systems, routes, third-party components, databases, middleware, authentication mechanisms, user environments, web servers, and/or other components related to the configuration of the environment.

Next, reconnaissance engine 202 generates 304, based on the reconnaissance data, a set of potential attack vectors for the environment. For example, reconnaissance engine 202 permutes URLs, input parameters, and/or other attributes related to requests to the environment. Reconnaissance engine 202 also transmits the requests to the environment and collects response times, response headers, response bodies, status codes, and/or other attributes of responses to the requests from the environment.

Classification engine 204 then classifies 306 a subset of the potential attack vectors as viable attack vectors for the environment based on features associated with the potential attack vectors. For example, classification engine 204 may generate the features as encodings and/or embeddings of attributes of the environment, response headers, response bodies, response times, error codes, and/or other data associated with requests and responses in the reconnaissance data. Classification engine 204 may also use clustering, PCA, and/or other techniques to reduce the dimensionality of the data and/or group the data into related types of attacks and/or targets. Classification engine 204 may then use unsupervised learning techniques to create an isolation forest, neural autoencoder, SVM, and/or another type of model that identifies anomalies or outliers in the features. Finally, classification engine 204 may identify hosts, services, URLs, endpoints, protocols, and/or other components of the environment associated with the outliers or anomalies as viable attack vectors for the environment.

Payload-generation engine 206 applies 308 a generative model to the viable attack vectors to produce a set of payloads for the viable attack vectors. For example, the generative model includes a GAN with a generator and a discriminator. Payload-generation engine 206 applies the generator to attributes of the viable attack vectors to produce a set of potential payloads. Payload-generation engine 206 then applies the discriminator to the set of potential payloads to identify a subset of the potential payloads that are indistinguishable from real payloads for use in a penetration test of the environment.

Finally, execution engine 238 dispatches 310 the payloads to the environment to assess security vulnerabilities in the environment. For example, execution engine 238 transmits, to the environment, requests that utilize the attack vectors and include the payloads during a scheduled penetration test of the environment. Execution engine 238 also collects responses to the payloads from the environment and applies classifiers from classification engine 204 to the responses to identify successful attacks as those associated with anomalous or outlier responses. Execution engine 238 then identifies the successful and/or unsuccessful attacks in a file, report, and/or other representation of results of the penetration test.

In sum, the disclosed embodiments provide generative attack instrumentation that improves the efficiency and/or comprehensiveness of penetration testing. In these embodiments, unsupervised classification techniques are used to identify viable attack vectors in reconnaissance data collected from an environment, and a GAN is used to generate payloads for the viable attack vectors. The payloads are then dispatched to the environment, and responses generated by the environment from the payloads are further classified to determine the success or failure of the corresponding attacks.

One advantage of the disclosed embodiments includes the ability to identify viable attack vectors without requiring manual labeling of anomalies or vulnerabilities in the reconnaissance data. Another advantage includes the ability to dynamically and automatically adapt payloads to different targets, services, configurations, and/or topologies in the environment under test. Consequently, the disclosed techniques provide improvements in computer systems, applications, tools, and/or technologies that identify attack vectors and generate payloads for use in penetration testing.

1. In some embodiments, a method for performing penetration testing comprises generating, based on reconnaissance data collected from an environment, a set of potential attack vectors for the environment; classifying a subset of the potential attack vectors as viable attack vectors for the environment based on features associated with the set of potential attack vectors; applying a generative model to the viable attack vectors to produce a set of payloads for the viable attack vectors; and dispatching the set of payloads to the environment to assess security vulnerabilities in the environment.

2. The method of clause 1, further comprising updating the generative model based on outcomes associated with the dispatched payloads.

3. The method of clauses 1-2, wherein updating the generative model based on the outcomes associated with the dispatched payloads comprises classifying an outcome associated with a payload dispatched to the environment based on a response received from the environment for the dispatched payload; and updating parameters of the generative model based on the classified outcome.

4. The method of clauses 1-3, further comprising collecting the reconnaissance data from the environment.

5. The method of clauses 1-4, wherein collecting the reconnaissance data from the environment comprises at least one of determining a topology of the environment and identifying components in the topology.

6. The method of clauses 1-5, wherein generating the set of potential attack vectors for the environment comprises permuting input parameters to the environment.

7. The method of clauses 1-6, wherein classifying the subset of the potential attack vectors as the viable attack vectors for the environment comprises at least one of encoding the features associated with the set of potential attack vectors; applying a clustering technique to the encoded features; and applying a classifier to the encoded features to classify the subset of the potential attack vectors as the viable attack vectors.

8. The method of clauses 1-7, wherein the classifier comprises at least one of an isolation forest, a support vector machine, a neural autoencoder, and a local outlier factor.

9. The method of clauses 1-8, wherein applying the generative model to the viable attack vectors comprises applying a generator in the generative model to attributes of the viable attack vectors to produce a set of potential payloads; and applying a discriminator in the generative model to the set of potential payloads to identify a subset of the potential payloads as indistinguishable from real payloads.

10. The method of clauses 1-9, wherein the attributes of the viable attack vectors comprise at least one of a Uniform Resource Locator (URL), parameters of the URL, a response time, an error code, a response header, and a response body.

11. The method of clauses 1-10, wherein the features associated with the set of potential attack vectors comprise at least one of an attribute of the environment, a response body, a response header, a response time, and an error code.

12. The method of clauses 1-11, wherein the environment comprises at least one of a host, a set of hosts, a domain, an application, a web service, a database, a website, a protocol, and a distributed system.

13. In some embodiments, a non-transitory computer readable medium stores instructions that, when executed by a processor, cause the processor to perform the steps of generating, based on reconnaissance data collected from an environment, a set of potential attack vectors for the environment; classifying a subset of the potential attack vectors as viable attack vectors for the environment based on features associated with the set of potential attack vectors; and assessing security vulnerabilities in the environment based on the viable attack vectors.

14. The non-transitory computer readable medium of clause 13, wherein the steps further comprise applying a generative model to the viable attack vectors to produce a set of payloads for the viable attack vectors.

15. The non-transitory computer readable medium of clauses 13-14, wherein applying the generative model to the viable attack vectors comprises applying a generator in the generative model to attributes of the viable attack vectors to produce a set of potential payloads; and applying a discriminator in the generative model to the set of potential payloads to identify the set of payloads as indistinguishable from real payloads.

16. The non-transitory computer readable medium of clauses 13-15, wherein the attributes of the viable attack vectors comprise at least one of a target Uniform Resource Locator (URL), parameters of the URL, a response time, an error code, a response header, and a response body.

17. The non-transitory computer readable medium of clauses 13-16, wherein the steps further comprise updating the generative model based on outcomes associated with the dispatched payloads.

18. The non-transitory computer readable medium of clauses 13-17, wherein updating the generative model based on the outcomes associated with the dispatched payloads comprises classifying an outcome associated with a payload dispatched to the environment based on a response received from the environment for the dispatched payload; and updating parameters of the generative model based on the classified outcome.

19. The non-transitory computer readable medium of clauses 13-18, wherein the features associated with the set of potential attack vectors comprise at least one of an attribute of the environment, a response body, a response header, a response time, and an error code.

20. In some embodiments, a system comprises a memory that stores instructions, and a processor that is coupled to the memory and, when executing the instructions, is configured to generate, based on reconnaissance data collected from an environment, a set of potential attack vectors for the environment; classify a subset of the potential attack vectors as viable attack vectors for the environment based on features associated with the set of potential attack vectors; apply a generative model to the viable attack vectors to produce a set of payloads for the viable attack vectors; and dispatch the set of payloads to the environment to assess security vulnerabilities in the environment.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for performing penetration testing, comprising:
generating, based on reconnaissance data collected from an environment, a set of potential attack vectors for the environment;
classifying a subset of the potential attack vectors as viable attack vectors for the environment based on features associated with the set of potential attack vectors;
applying a generative model to the viable attack vectors to produce a set of payloads for the viable attack vectors; and
dispatching the set of payloads to the environment to assess security vulnerabilities in the environment.

2. The method of claim 1, further comprising updating the generative model based on outcomes associated with the dispatched payloads.

3. The method of claim 2, wherein updating the generative model based on the outcomes associated with the dispatched payloads comprises:
classifying an outcome associated with a payload dispatched to the environment based on a response received from the environment for the dispatched payload; and
updating parameters of the generative model based on the classified outcome.

4. The method of claim 1, further comprising collecting the reconnaissance data from the environment.

5. The method of claim 4, wherein collecting the reconnaissance data from the environment comprises at least one of determining a topology of the environment and identifying components in the topology.

6. The method of claim 1, wherein generating the set of potential attack vectors for the environment comprises permuting input parameters to the environment.

7. The method of claim 1, wherein classifying the subset of the potential attack vectors as the viable attack vectors for the environment comprises at least one of:
encoding the features associated with the set of potential attack vectors;
applying a clustering technique to the encoded features; and
applying a classifier to the encoded features to classify the subset of the potential attack vectors as the viable attack vectors.

8. The method of claim 7, wherein the classifier comprises at least one of an isolation forest, a support vector machine, a neural autoencoder, and a local outlier factor.

9. The method of claim 1, wherein applying the generative model to the viable attack vectors comprises:
applying a generator in the generative model to attributes of the viable attack vectors to produce a set of potential payloads; and
applying a discriminator in the generative model to the set of potential payloads to identify a subset of the potential payloads as indistinguishable from real payloads.

10. The method of claim 9, wherein the attributes of the viable attack vectors comprise at least one of a Uniform Resource Locator (URL), parameters of the URL, a response time, an error code, a response header, and a response body.

11. The method of claim 1, wherein the features associated with the set of potential attack vectors comprise at least one of an attribute of the environment, a response body, a response header, a response time, and an error code.

12. The method of claim 1, wherein the environment comprises at least one of a host, a set of hosts, a domain, an application, a web service, a database, a website, a protocol, and a distributed system.

13. A non-transitory computer readable medium storing instructions that, when executed by a processor, cause the processor to perform the steps of:
generating, based on reconnaissance data collected from an environment, a set of potential attack vectors for the environment;
classifying a subset of the potential attack vectors as viable attack vectors for the environment based on features associated with the set of potential attack vectors; and
assessing security vulnerabilities in the environment based on the viable attack vectors.

14. The non-transitory computer readable medium of claim 13, wherein the steps further comprise applying a generative model to the viable attack vectors to produce a set of payloads for the viable attack vectors.

15. The non-transitory computer readable medium of claim 14, wherein applying the generative model to the viable attack vectors comprises:
applying a generator in the generative model to attributes of the viable attack vectors to produce a set of potential payloads; and
applying a discriminator in the generative model to the set of potential payloads to identify the set of payloads as indistinguishable from real payloads.

16. The non-transitory computer readable medium of claim 15, wherein the attributes of the viable attack vectors comprise at least one of a target Uniform Resource Locator (URL), parameters of the URL, a response time, an error code, a response header, and a response body.

17. The non-transitory computer readable medium of claim 14, wherein the steps further comprise updating the generative model based on outcomes associated with the dispatched payloads.

18. The non-transitory computer readable medium of claim 17, wherein updating the generative model based on the outcomes associated with the dispatched payloads comprises:
classifying an outcome associated with a payload dispatched to the environment based on a response received from the environment for the dispatched payload; and
updating parameters of the generative model based on the classified outcome.

19. The non-transitory computer readable medium of claim 13, wherein the features associated with the set of potential attack vectors comprise at least one of an attribute of the environment, a response body, a response header, a response time, and an error code.

20. A system, comprising:
a memory that stores instructions, and
a processor that is coupled to the memory and, when executing the instructions, is configured to:
generate, based on reconnaissance data collected from an environment, a set of potential attack vectors for the environment;
classify a subset of the potential attack vectors as viable attack vectors for the environment based on features associated with the set of potential attack vectors;
apply a generative model to the viable attack vectors to produce a set of payloads for the viable attack vectors; and
dispatch the set of payloads to the environment to assess security vulnerabilities in the environment.
